(19) United States
(12) Patent Application Publication
(10) Pub. No.: US 2026/0309184 A1
(43) Pub. Date: Oct. 8, 2026

(54) WEAR-RESISTANT BALL JOINT

(71) Applicant: JASON CO., LTD., PINGTUNG COUNTY (TW)

(72) Inventor: HUNG-YU CHEN, PINGTUNG COUNTY (TW)

(21) Appl. No.: 19/460,061

(22) Filed: Jan. 26, 2026

(30) Foreign Application Priority Data
Mar. 26, 2025 (TW) 114202999

(51) Int. Cl. F16C 11/06

(52) U.S. Cl. CPC F16C 11/0671

(57) ABSTRACT

A wear-resistant ball joint includes a base cap having a bending portion, a ball stud pivotally disposed on the base cap, and a sealing ring, an elastic ring, and a positioning ring respectively accommodated in the base cap. A hardness of the positioning ring is larger than a hardness of the elastic ring. Wherein, the positioning ring mainly includes an engaging surface in contact with the elastic ring and at least one engagement portion protruding from the engaging surface to provide a plurality of teeth units. The engagement portion is allowed to be embedded into the elastic ring to engage with and fix the positioning ring in position, thereby preventing the positioning ring from displacement, preventing an abrasion problem occurring between the positioning ring and the base cap, and extending the service life and durability of the ball joint.

### BACKGROUND OF THE INVENTION

### 1. Field of the Invention

This invention relates to a vehicle suspension component and relates particularly to a wear-resistant ball joint.

### 2. Description of the Related Art

Ball joint is one of the essential components using in machines or vehicles for connecting steering or suspension apparatuses. For example, when the ball joint is applied to a vehicle, it is applied to a connection between a vehicle body and a suspension apparatus or a connection between a steering apparatus and wheels so that the connection is capable of being rotated universally. Thus, the ball joint is widely used as a linking hinge.

Referring to FIG. 1, a conventional ball joint 1 includes a base cap 11, a ball stud 12 pivotally installed on the base cap 11, and a positioning ring 15, an elastic ring 14, and a sealing ring 13 respectively installed within the base cap 11. The base cap 11 has an inner cap wall 111 formed inside. An accommodation room 112 is enclosed by the inner cap wall 111. A bending portion 113 is formed on a peripheral edge of the base cap 11. The ball stud 12 of the ball joint 1 has a ball portion 121 situated within the accommodation room 112 for being in contact with the inner cap wall 111 and a shaft portion 122 extended outwards from the ball portion 121.

Referring to FIGS. 1, 2, and 2A, during the installation of the ball joint 1, the ball portion 121 is inserted into the accommodation room 112 and connected to the inner cap wall 111. The positioning ring 15, the elastic ring 14, and the sealing ring 13 sequentially pass the shaft portion 122 to be situated within the accommodation room 112 to allow the positioning ring 15 to be in contact with the ball portion 121. The bending portion 113 is formed by bending the peripheral edge of the base cap 11 so that the sealing ring 13, the elastic ring 14, and the positioning ring 15 are fixed in position by the bending portion 113. Thus, the installation of the ball joint 1 is completed. The shaft portion 122 which is situated outside of the accommodation room 112 of the base cap 11 is applied to be connected with other components.

After the installation of the ball joint 1 is completed, the ball joint 1 is operated. Because the positioning ring 15 is in contact with the base cap 11 and the ball portion 121, the rotation of the ball portion 121 caused when the shaft portion 122 is operated will move the positioning ring 15. The positioning ring 15 is restricted only by the frictional force generated when the elastic ring 14 and the positioning ring 15 are in contact with each other. Thus, when the ball stud 12 is operated, the positioning ring 15 which is in contact with the ball stud 12 is easily moved to result in the displacement of the positioning ring 15. Because the positioning ring 15 and the elastic ring 14 are not engaged tightly and properly, the positioning ring 15 and the elastic ring 14 will rub against each other, and that will result in a gap formed between the positioning ring 15 and the ball portion 121 and result in problems of loosening, abnormal shaking or noise during using. The service life of the ball joint 1 is shortened, and that requires to be improved.

### SUMMARY OF THE INVENTION

The object of this invention is to provide a wear-resistant ball joint capable of reducing improper abrasion effectively and prolonging the service life greatly.

The wear-resistant ball joint of this invention comprises a base cap, a ball stud pivotally disposed on the base cap, and a sealing ring, an elastic ring, and a positioning ring respectively disposed in the base cap. The base cap includes an inner cap wall, an accommodation room surrounded by the inner cap wall, and a bending portion formed on a peripheral edge. The ball stud includes a ball portion installed within the accommodation room for being in contact with the inner cap wall and a shaft portion protruding outwards from the ball portion and located outside of the accommodation room. A hardness of the positioning ring is greater than a hardness of the elastic ring. The positioning ring includes a contact surface in contact with the inner cap wall of the base cap and an engaging surface in contact with the elastic ring. At least one engagement portion protrudes outwards from the engaging surface. Each engagement portion includes a plurality of teeth units and a plurality of recessed areas. Crests of the teeth units are spaced apart from each other. Each recessed area is defined between every two adjacent teeth units. The ball portion of the ball stud is positioned in the accommodation room of the base cap. After the positioning ring, the elastic ring, and the sealing ring are sequentially arranged above the ball portion, the sealing ring is pressed by the bending portion of the base cap to allow the sealing ring to press the elastic ring and the positioning ring and to allow the positioning ring to be tightly engaged with the ball portion. The teeth units are embedded into the elastic ring when the engaging surface is pressed by the elastic ring, thereby achieving a tight engagement between the positioning ring and the elastic ring, preventing improper abrasion caused when the positioning ring and the elastic ring rub against each other during an operation of the ball stud, preventing improper abrasion of the positioning ring and the elastic ring effectively, and extending the service life and durability of the wear-resistant ball joint.

Preferably, a protrusion height defined by protruding the teeth units is above the engaging surface. A baseline is defined by the engaging surface. Flank surfaces of every two adjacent teeth units are connected to each other when each recess area is defined so that the protrusion height of every two adjacent teeth unit starts from a bottom of each recessed area. The bottom of each recessed area is located above the baseline.

Preferably, the teeth units differ in protrusion height so that the crests of the teeth units are not on a same line.

Preferably, the positioning ring includes a plurality of the engagement portions. The engagement portions are spaced apart from each other.

Preferably, the baseline is a horizontal baseline.

Preferably, the protrusion height of every two adjacent teeth unit starts from a lowest point at the bottom of each recessed area.

### BRIEF DESCRIPTION OF THE DRAWINGS

FIG. 1 is an exploded view showing a conventional ball joint;

FIG. 2 is a cross-sectional view showing a conventional ball joint;

FIG. 2A is an enlarged view of the encircled portion 2A indicated in FIG. 2;

FIG. 3 is an exploded view showing a first preferred embodiment of this invention;

FIG. 3A is an enlarged view of the encircled portion 3A indicated in FIG. 3;

FIG. 4 is a cross-sectional view showing the first preferred embodiment of this invention;

FIG. 4A is an enlarged view of the encircled portion 4A indicated in FIG. 4;

FIG. 5 is a cross-sectional view showing the positioning ring, with the teeth units equal in protrusion height;

FIG. 6 is a cross-sectional view showing another variation of the positioning ring, with the teeth units differ in protrusion height; and

FIG. 7 is a schematic view showing another variation of the first preferred embodiment of this invention characterized in a plurality of spaced-apart engagement portions.

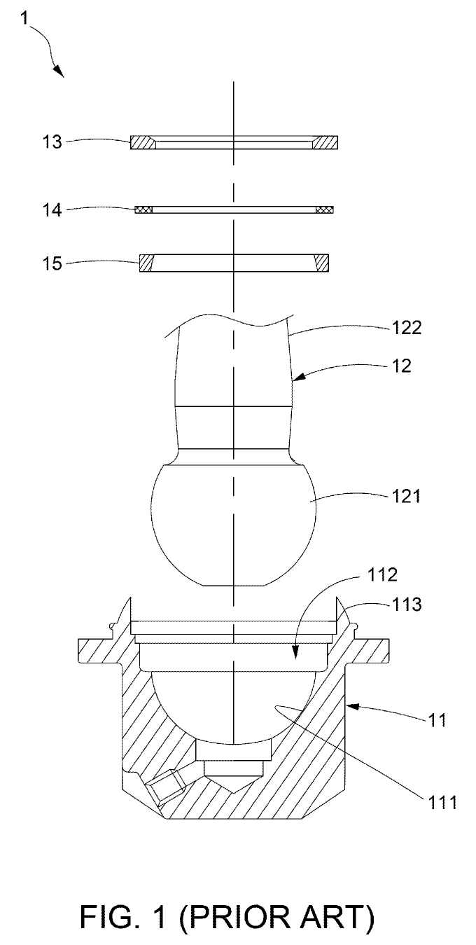

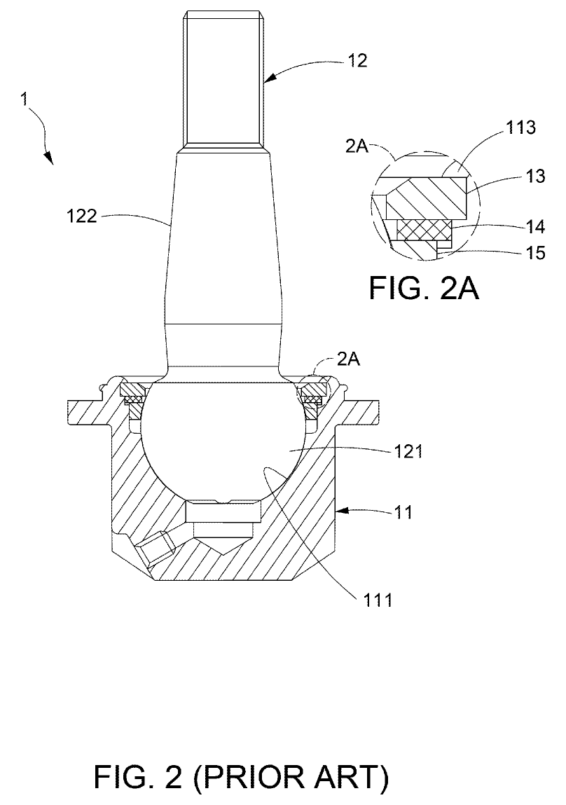

### DETAILED DESCRIPTION OF THE PREFERRED EMBODIMENTS

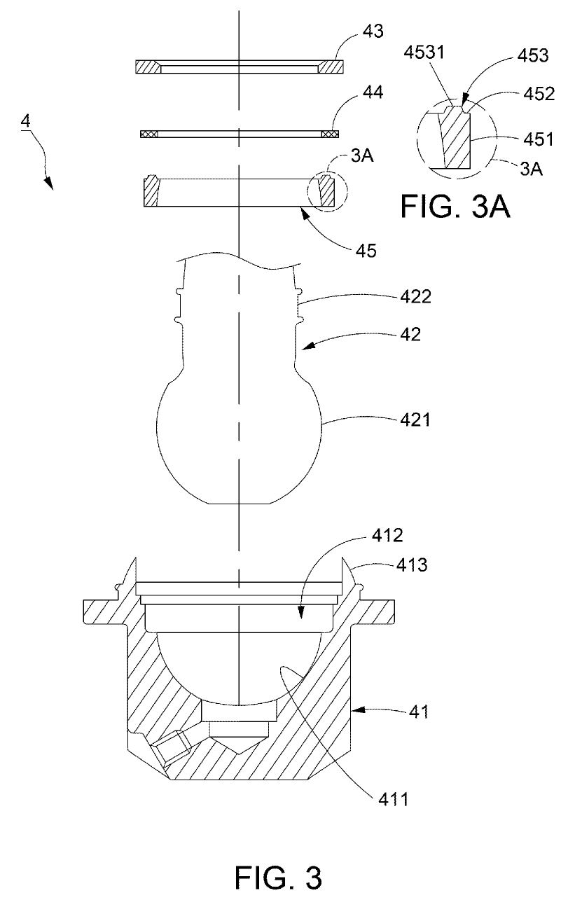

Referring to FIGS. 3, 4, and 5, a first preferred embodiment of a wear-resistant ball joint 4 of this invention comprises a base cap 41, a ball stud 42 pivotally disposed on the base cap 41, and a sealing ring 43, an elastic ring 44, and a positioning ring 45 respectively disposed in the base cap 41. The elastic ring 44 is situated above the positioning ring 45 and the sealing ring 43 is situated above the elastic ring 44 and opposite to the positioning ring 45. The wear-resistant ball joint 4 is adapted to be used in a vehicle suspension system. The ball stud 42 includes a ball portion 421 and a shaft portion 422 extended outwards from the ball portion 421. The shaft portion 422 is adapted to be connected to a component of a vehicle suspension system (not shown).

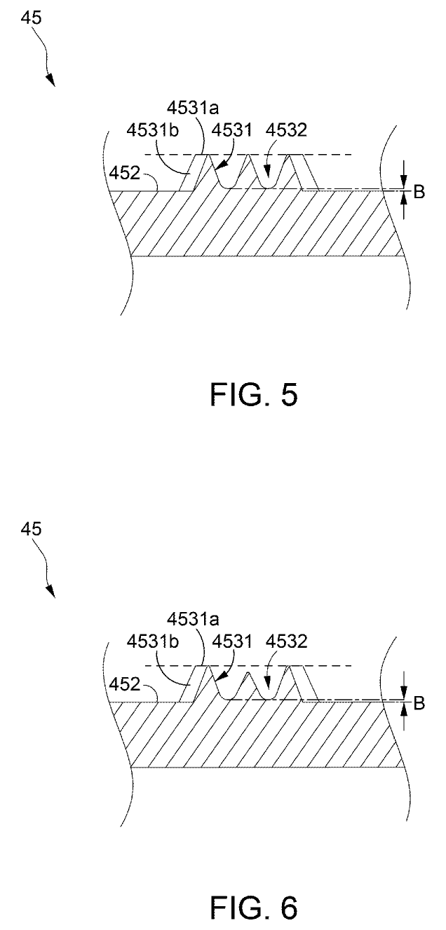

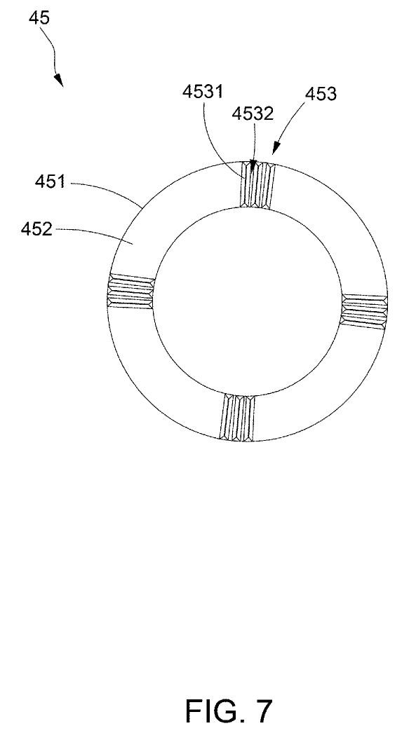

The base cap 41 includes an inner cap wall 411, an accommodation room 412 enclosed by the inner cap wall 411, and a bending portion 413 disposed on a peripheral edge. The accommodation room 412 is adapted to accommodate the ball portion 421 of the ball stud 42. The ball portion 421 is in contact with the inner cap wall 411 when the ball portion 421 is inserted into and situated within the accommodation room 412. The shaft portion 422 is disposed outside of the accommodation room 412 of the base cap 41. Referring to FIGS. 3 and 3A, the positioning ring 45 includes a contact surface 451 in contact with the inner cap wall 411 of the base cap 41 and an engaging surface 452 in contact with the elastic ring 44. The engaging surface 452 is different from the contact surface 451. When the positioning ring 45 is placed above the ball portion 421 , the contact surface 451 is in contact with the inner cap wall 411. At least one engagement portion 453 protrudes outwards from the engaging surface 452. Referring to FIG. 7, when more than one engagement portion 453 is applied, every two engagement portions 453 are preferably spaced apart from each other. Referring to FIG. 5, each engagement portion 453 includes a plurality of spaced-apart teeth units 4531. A recessed area 4532 is defined between every two connected teeth units 4531. Crests 4531a of the teeth units 4531 are spaced apart from each other. A protrusion height defined by protruding the teeth units 4531 is above the engaging surface 452. The protrusion height of each teeth unit 4531 is equal as shown in FIG. 5. Alternatively, the protrusion height of each teeth unit 4531 is different so that the crests 4531a of the teeth units 4531 are not on a same line as shown in FIG. 6 . Here takes an example that each teeth unit 4531 is arranged in the same protrusion height as shown in FIG. 5. Further, a baseline B is defined by the engaging surface 452. The baseline B is a horizontal baseline. Flank surfaces 4531b of every two adjacent teeth units 4531 are connected to each other when each recess area 4532 is defined so that the protrusion height of every two adjacent teeth unit 4531 starts from a lowest point at a bottom of each recessed area 4532. The bottom of each recessed area 4532 is located above the baseline B as shown in FIGS. 5 and 6.

Referring to FIG. 3, 4 and 5, in this preferred embodiment, the elastic ring 44 is made of plastic. A hardness of the elastic ring 44 is less than a hardness of the positioning ring 45. The elasticity of the elastic ring 44 allows the elastic ring 44 to recover size and shape after deformation and compression. The elastic ring 44 is in contact with the positioning ring 45. The sealing ring 43 is in contact with the elastic ring 43.

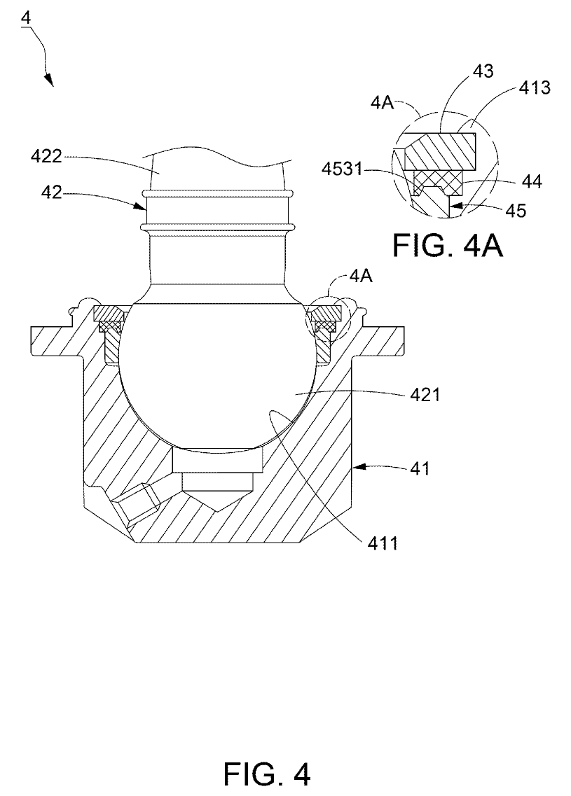

Referring to FIG. 3, 4 and 5, during the installation of the wear-resistant ball joint 4, the ball portion 421 is placed into the accommodation room 412. The shaft portion 422 is exposed outside of the accommodation room 412. The positioning ring 45, the elastic ring 44, and the sealing ring 43 are sequentially placed on the ball portion 421 and situated in the accommodation room 412. Namely, the positioning ring 45, the elastic ring 44, and the sealing ring 43 sequentially pass the shaft portion 422 to be placed into the accommodation room 412. The bending portion 413 is then formed by bending the peripheral edge of the base cap 41. Thus, the bending portion 413 extends in the direction of the accommodation room 412 and presses the sealing ring 43, the elastic ring 44, and the positioning ring 45. The positioning ring 45 is in contact with the ball portion 421 tightly and the ball portion 421 is confined in the accommodation room 412. The elastic ring 44 is pressed and engaged with the positioning ring 45. The positioning ring 45 is positioned properly while the contact surface 451 is in contact with the inner cap wall 411 and the engaging surface 452 is in contact with the elastic ring 44. Thus, the ball portion 421, the positioning ring 45, the elastic ring 44, and the sealing ring 43 are restricted within the accommodation room 412 properly whereby the ball stud 42 is pivotally connected to the base cap 41. Referring to FIGS. 4 and 4A, the teeth units 4531 are embedded into the elastic ring 44 when the elastic ring 44, the sealing ring 43, and the positioning ring 45 are pressed by the bending portion 413, thereby tightly engaging the positioning ring 45 and the elastic ring 44 with each other, preventing the positioning ring 45 from rubbing against the elastic ring 44 when the ball portion 421 of the ball stud 42 is operated, preventing gaps caused by improper abrasion, allowing the positioning ring 45, the elastic ring 44, and the sealing ring 43 to be confined in the accommodation room 412 properly, and extending the service life and improving the durability of the wear-resistant ball joint 4.

The sealing ring 43 is pressed by the bending portion 413 to allow the elastic ring 44, the positioning ring 45, and the ball portion 421 to be in close contact with the base cap 41. The ball portion 421 closely abuts against the inner cap wall 411 and the positioning ring 45 for being capable of rotating. The positioning ring 45 is situated on a top of the ball portion 421 and closely abuts against the elastic ring 44. The engagement portion 453 disposed on the positioning ring 45 is inserted into and buried into the elastic ring 44 when the engaging surface 452 is tightly pressed by the elastic ring 44 so that the positioning ring 45 and the elastic ring 44 are engaged tightly, thereby preventing the elastic ring 44 from being moved caused by the rotation of the ball portion 421, preventing the positioning ring 45 from rubbing against the elastic ring 44, and increasing the service life and the durability of the wear-resistant ball joint 4.

When the sealing ring 43 is pressed by the bending portion 413, the elastic ring 44 is pressed by the sealing ring 43 and the positioning ring 45 is pressed by the elastic ring 44 to be in contact with the ball portion 421. Thus, the ball portion 421 closely abuts against the inner cap wall 411. When the bending portion 413 is adapted to position the sealing ring 43, the elastic ring 44, and the positioning ring 45, the ball portion 421 is in close contact with the inner cap wall 411 with the aid of the positioning ring 45. The elasticity of the elastic ring 44 assists in preventing the engagement between the ball portion 421 and the inner cap wall 411 of the base cap 41 from improperly tight and reducing the pressing and frictional force generated between the ball portion 421 and the inner cap wall 411 of the base cap 41, thereby extending the service life of the ball portion 421, the base cap 41, and the positioning ring 45.

To sum up, the wear-resistant ball joint of this invention takes advantages that at least one engagement portion protrudes from the engaging surface of the positioning ring which is in contact with the elastic ring. When the engaging surface of the positioning ring is engaged with the elastic ring, the engagement portion is embedded into the elastic ring and engaged with the elastic ring, thereby preventing the improper abrasion of the positioning ring, preventing the ball portion from rubbing against the base cap improperly, and effectively extending the service life and the durability of the wear-resistant ball joint.

While the embodiments of this invention are shown and described, it is understood that further variations and modifications may be made without departing from the scope of this invention.

What is claimed is:

1. A wear-resistant ball joint comprising a base cap, a ball stud pivotally disposed on said base cap, and a sealing ring, an elastic ring, and a positioning ring respectively disposed in said base cap; with said positioning ring placed in said base cap in position, said elastic ring situated above said positioning ring, and said sealing ring situated above said elastic ring, wherein said base cap includes an inner cap wall and an accommodation room enclosed by said inner cap wall, a bending portion being disposed on a peripheral edge of said base cap, said ball stud including a ball portion disposed within said accommodation room for being in contact with said inner cap wall and a shaft portion extended outwards from said ball portion and disposed outside of said accommodation room of said base cap, wherein said sealing ring, said elastic ring, and said positioning ring are sequentially placed into said accommodation room and pressed by said bending portion, thereby fixing said ball portion, said sealing ring, and said positioning ring in position, wherein said positioning ring, said elastic ring, and said sealing ring are confined in said accommodation room after said peripheral edge of said base cap is bent to form said bending portion whereby said ball stud is pivotally connected to said base cap;
wherein a hardness of said positioning ring is greater than a hardness of said elastic ring, said positioning ring including a contact surface in contact with said inner cap wall and an engaging surface in contact with said elastic ring, wherein at least one engagement portion protrudes outwards from said engaging surface, each said engagement portion including a plurality of spaced-apart teeth units and a plurality of recessed areas, with crests of said plurality of teeth units being spaced apart from each other, each of said plurality of recessed areas being defined between every two adjacent teeth units, wherein said plurality of teeth units are embedded into said elastic ring when said elastic ring, said sealing ring, and said positioning ring are pressed by said bending portion, thus tightly engaging said positioning ring and said elastic ring with each other.

2. The wear-resistant ball joint according to claim 1, wherein a protrusion height defined by protruding said plurality of teeth units is above said engaging surface, wherein a baseline is defined by said engaging surface, flank surfaces of said every two adjacent teeth units are connected to each other when each said recess area is defined so that said protrusion height of said every two adjacent teeth unit starts from a bottom of each said recessed area, said bottom of each said recessed area being located above said baseline.

3. The wear-resistant ball joint according to claim 1, wherein said plurality of teeth units differ in protrusion height so that said crests of said plurality of teeth units are not on a same line.

4. The wear-resistant ball joint according to claim 1, wherein said positioning ring includes a plurality of said engagement portions, said plurality of engagement portions being spaced apart from each other.

5. The wear-resistant ball joint according to claim 2, wherein said baseline is a horizontal baseline.

6. The wear-resistant ball joint according to claim 2, wherein said protrusion height of said every two adjacent teeth unit starts from a lowest point at said bottom of each said recessed area.
